(19) United States
(12) Patent Application Publication
(10) Pub. No.: US 2026/0064482 A1
(43) Pub. Date: Mar. 5, 2026

(54) WORKLOAD RESOURCE ALLOCATION USING A MACHINE LEARNING MODEL

(71) Applicant: HEWLETT PACKARD ENTERPRISE DEVELOPMENT LP, Spring, TX (US)

(72) Inventors: Lalit Somavarapha, San Jose, CA (US); Gernot Seidler, San Jose, CA (US); Swami Viswanathan, Morgan Hill, CA (US)

(21) Appl. No.: 18/818,808

(22) Filed: Aug. 29, 2024

(51) Int. Cl. G06F 9/50; G06F 9/455; G06N 20/00

(52) U.S. Cl. CPC G06F 9/505; G06F 9/45558; G06N 20/00; G06F 2009/4557

(57) ABSTRACT

In some examples, a system receives, from a requester, a request to perform a first workload in a virtual computing environment, and determines a type of the requester, the determined type being one of a plurality of different requester types. The system receives metrics relating to resource usage in the virtual computing environment, and determines, using a machine learning model, an allocation of resources to the first workload based on the determined type of the requester and the metrics. The machine learning model adjusts the allocation of resources to the first workload based on further collected metrics relating to resource usage by the workload and based on a detected behavior of the requester while the first workload is performed in the virtual computing environment.

### BACKGROUND

A computer system can include a virtual computing environment in which virtual compute entities, such as containers or virtual machines (VMs), can execute. The virtual compute entities can be used to perform workloads initiated by requesters.

### BRIEF DESCRIPTION OF THE DRAWINGS

Some implementations of the present disclosure are described with respect to the following figures.

FIG. 1 is a block diagram of an arrangement including a proactive workload management engine and other components, according to some examples.

FIG. 2 is a flow diagram of a proactive workload management process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A virtual computing environment can support scalability and agility by adjusting the number of virtual compute entities that are run to meet demands of requesters. A requester can initiate a workload that is to be performed by virtual compute entities. However, various issues are associated with management of workloads in a virtual computing environment. Virtual compute entities deployed to perform the workloads can contend for resources of a computer system. Insufficient allocation of resources to a workload can cause the performance of the workload to suffer. For example, the workload may take a long time to complete, or unexpected restarts of the workload may occur. Additionally, there may be a lack of timely visibility into resource consumption by workloads, which can prevent an organization from understanding why workload performance is suffering and determining what actions to take to improve workload performance.

Some example approaches may use reactive scaling of resources for workloads, in which administrators or other users may monitor, using monitoring tools, operations of workloads in a virtual computing environment and manually or programmatically adjust allocations of resources to the workloads to meet target goals, such as Quality of Service (QoS) targets. However, such reactive scaling approaches may result in suboptimal allocations of resources to workloads, including either over-provisioning or under-provisioning of resources for workloads. Over-provisioning of resources for workloads leads to inefficient allocation of resources that increases cost, while under-provisioning of resources for workloads leads to workload performance issues. Also, manual adjustment of resource allocations is labor intensive and can be slow, resulting in reduced agility in workload management in a virtual computing environment.

In accordance with some implementations of the present disclosure, proactive workload management systems or techniques are able to perform predictive adjustments of resources allocated to workloads in a virtual computing environment based on monitored metrics, types of requesters, and monitored behaviors of the requesters. Adjusting resources can involve any or some combination of the following: adjust how many virtual compute entities are used to perform a workload, adjust which physical computing nodes of a computer system the virtual compute entities are run on, select types of physical resources used by the virtual compute entities, or any other adjustment in which the quantity or nature of resources used by a workload is changed. A “resource” can thus refer to a virtual compute entity or a physical resource.

In some examples, a workload management system determines a type of a requester that requested performance of a workload, receives metrics relating to resource usage in the virtual computing environment, determines, using a machine learning model, an allocation of resources to the workload based on the determined type of the requester and the metrics, and dynamically adjusts, using the machine learning model, the allocation of resources to the workload based on further collected metrics relating to resource usage by the workload and based on a detected behavior of the requester while the workload is performed in the virtual computing environment. Note that there may be multiple machine learning models used, such as one machine learning model per requester or group of requesters.

The workload management system is able to predict periods increased or decreased workloads using the machine learning model that is continually (or iteratively) refined, so that proactive adjustments of resource allocations can be performed to meet demands and to avoid over-provisioning of resources, which reduces costs and increases efficiency.

In the ensuing discussion, reference is made to examples in which a requester of a workload is a user. In further examples, techniques or mechanisms according to some implementations of the present disclosure can be applied for other types of requesters, including programs or machines. Also, in the ensuing discussion, reference is made to using containers to perform workloads. In other examples, other types of virtual compute entities, such as VMs, can be used to perform workloads in a virtual computing environment.

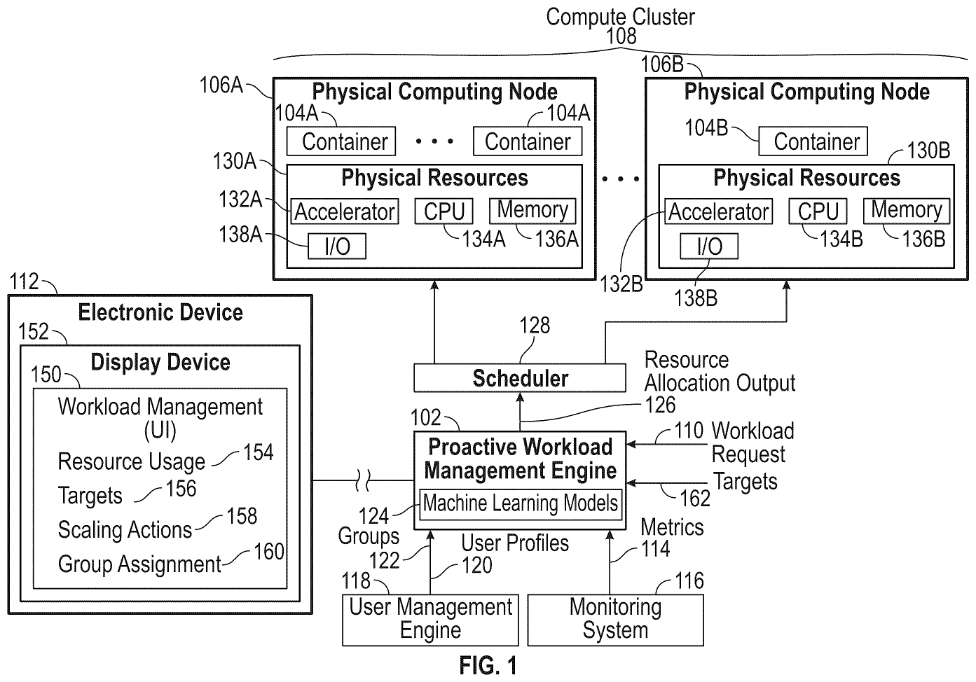

FIG. 1 is a block diagram of an example arrangement that includes a proactive workload management engine 102 that can manage workloads requested by users to be performed with containers executed in physical computing nodes. In the example of FIG. 1, containers 104A are executed in a physical computing node 106A, and a container 104B is executed in a physical computing node 106B. In other examples, a physical computing node can include a different quantity of containers than those shown in FIG. 1. Also, although FIG. 1 shows an example with two physical computing nodes, in other examples, a different quantity (one or more) of physical computing nodes can be employed.

In some examples, the physical computing nodes 106A and 106B are part of a compute cluster 108, which refers to a group of physical computing nodes (or worker machines). An example of the compute cluster 108 is a Kubernetes cluster that runs containerized applications (which are applications executed in respective containers). With Kubernetes, containers are included in pods, where a pod includes a specific quantity of containers. Although reference is made to Kubernetes, in other examples, containers can be according to other technologies.

The proactive workload management engine 102 receives a workload request 110 to initiate a workload using containers in the compute cluster 108. The workload request 110 can be initiated by a user and received from an electronic device (e.g., 112 in FIG. 1) of the user.

The proactive workload management engine 102 further receives metrics 114 from a monitoring system 116. The monitoring system 116 can include sensors in the compute cluster 108 that are able to collect metrics associated with operations of the compute cluster 108 while workloads are performed by containers on respective physical computing nodes 106A and 106B. A sensor can refer to a hardware sensor or a sensor implemented using machine-readable instructions.

In addition, a user management engine 118 can be used for defining user profiles 120 for respective different users that are able to submit workload requests to the proactive workload management engine 102. The user management engine 118 can also define groups, where a group represents a group of user profiles. The user management engine 118 can provide groups information 122 that define the groups. As discussed further below, a given user can be assigned to a group based on the user profile of the given user.

The proactive workload management engine 102 includes machine learning models 124, where each machine learning model 124 can be used in determining an allocation of resources to a respective workload. In some examples, customized machine learning models may be associated with respective different users (or other types of requesters) or different groups of users (or groups of other types of requesters). In the ensuing discussion, reference is made to “the machine learning model 124” in the singular sense. However, it is noted that for workloads of different requesters or groups of requesters, different machine learning models 124 may be employed.

In addition, the machine learning model 124 can continually adjust the allocation of resources in response to changing conditions as the workload executes. The machine learning model 124 can be initially trained using a training data set. In addition, the machine learning model 124 can be updated due to learning using the machine learning model 124 based on monitoring of workload executions in the compute cluster 108. Note that an allocation of resources can further be based on a quota of resources assigned to the user and available resources in the compute cluster 108.

Examples of machine learning models that can be used include any or some combination of the following: classification models such as multi-label random forests or cost-sensitive decision trees, tabular transformer models, or other types of machine learning models. The machine learning model 124 can be trained using training data obtained by collecting metrics and usage data from existing deployments of compute clusters performing workloads in various usage scenarios. The machine learning model 124 can be fine-tuned with continually collected metrics and usage data from the compute cluster 108 when executing production workloads. For example, training a random forest model can include setting hyperparameters of the random forest model using a training data set. As another example, training a cost-sensitive decision tree includes growing the decision tree based on a training data set.

The proactive workload management engine 102 can provide a resource allocation output 126 to a scheduler 128. In some examples, the machine learning model 124 can produce an output including labels or parameters relating to different resources, and the proactive workload management engine 102 can use the output labels or parameters to generate a representation of the resource allocation to provide as the resource allocation output 126 to the scheduler 128. The resource allocation output 126 includes information specifying an allocation of resources to a workload produced using the machine learning model 124. Examples of resources that can be allocated include any or some combination of the following: a quantity of containers to use (or a number of pods to use) for the workload, which physical computing nodes the containers are to run on, types of physical resources to employ for executing the workload, or other types of resources.

The scheduler 128 schedules workloads using the resources specified by the resource allocation output 126. For example, based on the resource allocation output 126, the scheduler 128 can schedule execution of a workload using the specified quantity of containers (or pods), on one or more specified physical computing nodes, and using specific type(s) of physical resources. In examples where the compute cluster 108 is a Kubernetes cluster, the scheduler 128 can be a Kubernetes scheduler. In other examples, different types of schedulers can be employed.

As depicted in FIG. 1, the physical computing node 106A includes physical resources 130A, which include an accelerator 132A (e.g., a graphics processing unit (GPU), a data processing unit (DPU), a tensor processing unit (TPU), an application-specific integrated circuit device, or another type of specialized processor), a central processing unit (CPU) 134A, a memory 136A, an input/output (I/O) device 138A, and other types of resources. Similarly, the physical computing node 106B includes physical resources 130B, which include an accelerator 132B, a CPU 134B, a memory 136B, an I/O device 138B, and other resources. Examples of I/O devices can include any or some combination of the following: a network interface controller, a disk-based storage, a graphics controller, or any other type of device that can perform I/O operations. A CPU is used to execute primary machine-readable instructions such as an operating system (OS), system firmware, and an application program. An accelerator is a specialized processor which may provide higher performance and power efficiency than a CPU for specific types of operations, such as operations associated with artificial intelligence workloads or any other operations that involve intensive mathematical operations. The resource allocation output 126 can specify the use of any one or more of the foregoing physical resources.

The proactive workload management engine 102 can also present a workload management user interface (UI) 150 in a display device 152 of the electronic device 112. The workload management UI 150 provides various insights regarding workloads in the compute cluster 108. Examples of information that can be presented in the workload management UI 150 include resource usage information 154 specifying usage of resources by a workload, targets 156 that have been set for the workload, scaling actions 158 (including scaling actions that have been performed for the workload and/or upcoming scaling actions for the workload, where a “scaling action” can refer to an adjustment of a resource allocation), and group assignment information 160 (which refers to the assignment of a user profile to a group). The information presented in the workload management UI 150 enhances user understanding of the compute cluster's configuration and performance, and aids in troubleshooting when issues arise in the compute cluster 108.

In some examples, the proactive workload management engine 102 can deliver real-time insights regarding workload performance and system optimization. Insights are delivered in “real-time” if various information produced or considered by the proactive workload management engine 102 are provided in the workload management UI 150 as the information is produced or used. A user can customize the visualization of the information presented in the workload management UI 150, including selecting the type of presentation (e.g., graphical format, text format, etc.), numerical ranges to use, and so forth. The user can also adjust the granularity of the information presented, including a time range, information presented per workload, information presented per user or application, and so forth.

The following are examples of metrics 114 collected by the monitoring system 116. The metrics 114 can include resource usage information, e.g., usage of a CPU, usage of a GPU, usage of a memory, and usage of an I/O device. The metrics 114 can further include resource request information, which can identify specific resources requested by a workload. The metrics 114 can also include resource caps, which specify limits on use of certain resources. The metrics 114 can also include performance metrics regarding how well workloads are performing, such as time taken to complete the workloads, any restarts of the workloads, whether the workloads are meeting performance goals such as QoS goals, or other performance metrics.

The metrics 114 allow the proactive workload management engine 102 to determine any or some combination of the following in the compute cluster 108: the computational load of workloads, bottlenecks faced by workloads, over-allocation or under-allocation of resources, computational requirements of workloads, memory requirements of workloads, I/O requirements of workloads, or other resource related issues or information relating to how workloads are performing and resources used by the workloads.

In some examples, the metrics 114 collected by the monitoring system 116 can further include information associating usage of specific resources with particular users, applications, or individual workloads. In this way, the proactive workload management engine 102 can present granular information (such as in the workload management UI 150) regarding resource consumption patterns of users, applications, or workloads. Further metrics 114 can include timestamps that can represent user login times, times at which resources were used, or other time information. The metrics 114 may also include historical usage information that tracks how users, applications, or workloads have used resources historically. Such historical usage information may be used by the machine learning model 124 to make future predictions of resource usage.

Additional metrics 114 can include geographic locations of where workloads are executed, types of workloads (e.g., compute-intensive workloads that make intensive use of processing resources, memory-intensive workloads that have large numbers of memory accesses, or I/O-intensive workloads that perform large numbers of network communications or accesses of disk-based storage devices).

The proactive workload management engine 102 can further receive targets 162 relating to resource usage. The targets 162 may be set by one or more administrative entities, such as human administrators, administrative programs, or administrative machines. A “target” can refer to a threshold that defines a cap or a floor relating to usage of a resource. Additionally or alternatively, a “target” can refer to a goal relating to usage of a resource. The goal can be expressed as a range of usage of a particular resource that a workload should be allocated by the proactive workload management engine 102 during execution of the workload. More generally, a “target” can refer to a target for a metric (or a collection of metrics). The targets 162 may be granular targets configurable across different types of users, different geographic regions, different organizations, different tenants, and so forth.

The targets 162 can be used by the machine learning model 124 to generate scaling actions for adjusting resource allocations. The adjustment of an allocation of resources can be to achieve a usage resource that satisfies one or more of the targets 162. For example, a cap on resource usage can prevent individual workloads from monopolizing resources and impacting other workloads. Additionally, by comparing actual resource usage against the targets 162, the proactive workload management engine 102 can identify containers that are over-provisioned (wasting resources) or under-provisioned (potentially causing performance issues).

As noted above, the workload management UI 150 presented by the proactive workload management engine 102 includes the targets 156, which can include the targets 162 received by the proactive workload management engine 102. Presenting the targets 162 in the workload management UI 150 allows a user (such as an administrator) to monitor resource usage thresholds that may affect workload performance.

In addition, the resource usage information 154 presented by the proactive workload management engine 102 can aid in the profiling of users. For example, an administrator can use the user management engine 118 to modify a user profile of a particular user based on the resource usage information 154. Modifying the user profile of the particular user can affect which group selected from multiple groups the particular user is assigned to.

The administrator may also adjust one or more targets 162 based on recommendations from the proactive workload management engine 102. Adjusting a target 162 may lead to cost savings if resource allocations can meet the adjusted target 162 while still meeting performance goads of a workload. For example, the proactive workload management engine 102 can detect that workloads of a given user are consistently using more or less resources than initially allocated using the machine learning model 124. In this case, the proactive workload management engine 102 can provide a recommendation (through the workload management UI 150) to increase or decrease one or more targets 162 so that more or less resources can be allocated for the workloads of the user. As another example, the proactive workload management engine 102 can detect based on performance metrics of workloads that the workloads are not meeting performance goals. In such cases, the proactive workload management engine 102 can provide a recommendation (through the workload management UI 150) to increase one or more targets 162 so that more resources can be allocated to meet performance goals.

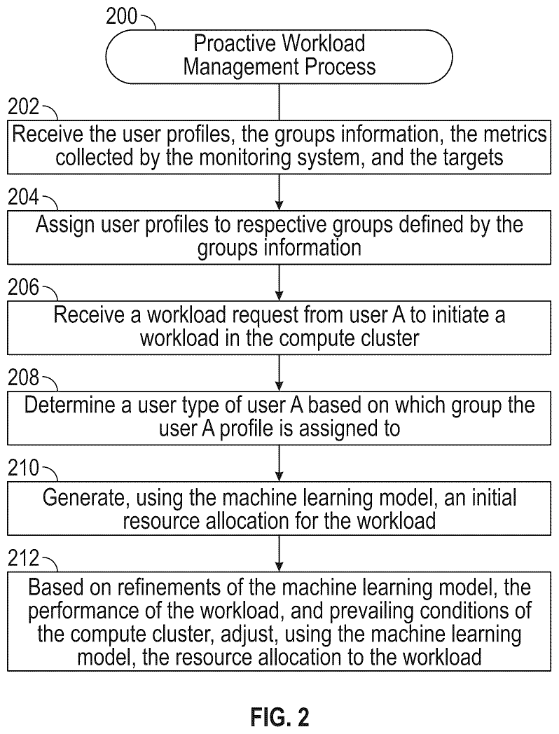

FIG. 2 is a flow diagram of a process 200 of the proactive workload management engine 102 according to some examples. FIG. 2 shows an order of tasks. In other examples, the tasks can be performed in a different order, some tasks may be omitted, and other tasks may be added.

The proactive workload management engine 102 receives (at 202) the user profiles 120, the groups information 122, the metrics 114 collected by the monitoring system 116, and the targets 162.

The proactive workload management engine 102 can assign (at 204) user profiles to respective groups defined by the groups information 122. A group includes a collection of user profiles that are similar to one another. The group that a particular user profile belongs to provides an indication of the type of user. For example, a first group corresponds to power users who initiate workloads with heavy resource consumptions. A second group corresponds to regular users who initiate workloads with average or typical resource consumptions. A third group corresponds to occasional users who infrequently initiate workloads on the compute cluster 108. Although examples of groups are listed above, in other examples, there may be other types of groups indicating other types of users. The assignment of user profiles to groups is discussed further below.

The proactive workload management engine 102 receives (at 206) a workload request (e.g., 110 in FIG. 1) from user A to initiate a workload in the compute cluster 108. User A is associated with a user profile 120 (referred to as the “user A profile”), which may have been assigned (at 204) to a particular group. If not already assigned to a group, the proactive workload management engine 102 can assign the user A profile to a selected group of the groups represented by the groups information 122.

The proactive workload management engine 102 determines (at 208) a user type of user A based on which group the user A profile is assigned to. Based on various inputs including the determined user type of user A, the metrics 114, and the targets 162, the machine learning model 124 of the proactive workload management engine 102 can generate (at 210) an initial resource allocation for the workload. For each group, the machine learning model 124 can identify typical resource usage pattern and performance levels, and can base the initial resource allocation on such typical resource usage pattern and performance levels.

Resources assigned in the initial resource allocation can include any or some combination of the following: a quantity of containers (from among the containers in the physical compute nodes 106A to 106B) to use (or a number of pods to use) for the workload, which physical computing nodes 106A to 106B the containers are to run on, types of physical resources (e.g., GPU versus CPU, CPU with higher operating speed versus CPU with lower operating speed, etc.) to employ for executing the workload, or other types of resources.

In addition to the foregoing inputs, the machine learning model 124 may also consider other inputs, including any or some combination of a time of the requested workload, a number of workloads currently running or requested to run, a geographic region of the workload, or other information. For example, if the workload is to execute during peak usage hours (such as during business hours of an organization) in a given geographic region, that would impact the resource allocation for the workload since the machine learning model 124 has to consider competing resource requirements of other workloads.

In generating the resource allocation, the machine learning model 124 can predict or forecast upcoming resource demands of workloads and proactively trigger scaling actions, preventing bottlenecks before they impact performance. The machine learning model 124 is continually learning and is able to dynamically refine its logic based on evolving patterns. Based on refinements of the machine learning model 124, the performance of the workload, and prevailing conditions of the compute cluster 108, the machine learning model 124 can adjust (at 212) the resource allocation to the workload. For example, the machine learning model 124 can reduce or increase the quantity of containers (or pods) assigned to the workload, change from using CPUs to using GPUs (or vice versa), change an allocation of memory, and so forth.

The proactive workload management engine 102 can implement dampening to avoid rapid adjustments of resource allocations. For example, the dampening can result in gradual increases in allocations of resources and/or gradual decreases in allocations of resources, to avoid over-provisioning or under-provisioning resources, respectively, for a workload.

The adjustment of the resource allocation can also be based on a monitored behavior of user A. User A may be expected to request workloads of one or more specific workload types, e.g., workloads relating to developing AI systems or relating to scientific research. The group that user A is assigned to may indicate that users belonging to the group are expected to submit workloads of the one or more specific workload types. If the machine learning model 124 detects that workloads requested by user A are of a second type different from the any of the one or more specific workload types, the machine learning model 124 can take remediation action, such as by reducing a resource allocation to the workloads requested by user A.

More generally, if the machine learning model 124 detects (at 212) that a behavior of user A has deviated from an expected behavior, then the machine learning model 124 can adjust (at 210) the resource allocation to the workload of user A.

Other examples of workloads that may be requested by different users can include processing and analytics of streaming data, predictive data analytics for producing recommendations, diagnostic workloads using machine learning techniques, generative AI workloads such as workloads involving large language models (LLMs) (e.g., workloads in which queries are submitted to chatbots that produce answers to the queries), data backup workloads, or other types of workloads. Some workloads may perform repetitive mathematical computations such as AI or machine learning workloads, in which case accelerators (e.g., 132A, 132B in FIG. 1) can be selected for executing these workloads for improved performance. Other workloads may involve executions of large programs, which may benefit from selecting CPUs (e.g., 134A, 134B in FIG. 1) to use for executing such workloads. Different workloads may be requested by different types of users, such as individual users (e.g., data scientists, data analysts, system administrators, etc.), users that are associated with automated jobs (such as in a factory), product engineers, financial department personnel, executive office personnel, and so forth.

The following describes an example of how a user profile is assigned to a group of user profiles. It is assumed there are N (N≥2) groups of user profiles, which may be defined by an administrator or another entity. A user profile includes a collection (e.g., a vector) of attributes (a multi-dimensional data point), where the attributes (dimensions) can represent a resource usage pattern and performance levels associated with workloads of a user. For example, the vector of attributes making up the user profile can include any or some combination of the following: an attribute representing CPU usage, an attribute representing GPU usage, an attribute representing memory usage, an attribute representing I/O usage, attributes representing performance metrics, or other attributes. In further examples, the vector of attributes that make up the user profile can further include one or more of information relating to a role of the user (e.g., which department of an organization the user belongs to, whether the user is a guest or an employee, or any other role), one or more allowed types of resources that the user is allowed to use, or permission information of the user (e.g., specifying a privilege or security level of the user).

The proactive workload management engine 102 can determine which group of the N groups the user profile should be assigned based on similarities of the user profile to the corresponding N groups. The similarities may be represented by distances in vector space of the user profile to the corresponding N groups. Each group of profiles has a center in the vector space that is computed based on the user profiles represented by the group of profiles.

A maximum distance Dₑₚₛ can be defined. For a given user profile, the proactive workload management engine 102 calculates a distance (in the vector space) of the given user profile to the center corresponding to each of the N groups. If the distance of the given user profile to the center of a particular group of user profiles is less than or equal the maximum distance Dₑₚₛ, the given user profile is assigned to the particular group of user profiles.

If the given user profile is outside the maximum distance Dₑₚₛ to all N groups (this given user profile is an outlier), the proactive workload management engine 102 may either (1) create a new group of user profiles if a sufficient quantity of outliers have been detected by the proactive workload management engine 102, or (2) assign the given user profile to the nearest group of user profiles. If option (2) is selected, then the proactive workload management engine 102 can recalculate the center of the group of user profiles to which the given user profile is assigned. For example, if the given user profile is assigned to group X that has a set of existing user profiles, then the recalculation of the center of group X is based on the set of existing user profiles plus the newly assigned given user profile.

As noted above, the assignment of a user profile to a group of user profiles determines a type of the user associated with the user profile, which the machine learning model 124 uses to produce an initial resource allocation for a workload of the user. In some cases, the group assignment information 160 presented in the workload management UI 150 can provide information of a group to which a user is assigned, as well as a distance of a user profile of the user to various groups so that an administrator can understand proximities of the user to the groups.

Use of the proactive workload management engine 102 allows for automated assignment of resources to workloads that can meet performance targets of the workloads while enhancing efficiency and reducing cost. The proactive workload management engine 102 can detect a deviation of a user behavior from an expected behavior, and can adjust a resource allocation to a workload of the user in response. The proactive workload management engine 102 can manage a diverse base of users and can automatically assign the users to respective groups that can be used to determine resource allocations. Targets (thresholds) can be considered by the proactive workload management engine 102 in generating scaling actions. The targets can also be dynamically adjusted with changing conditions to improve resource allocations provided by the proactive workload management engine 102.

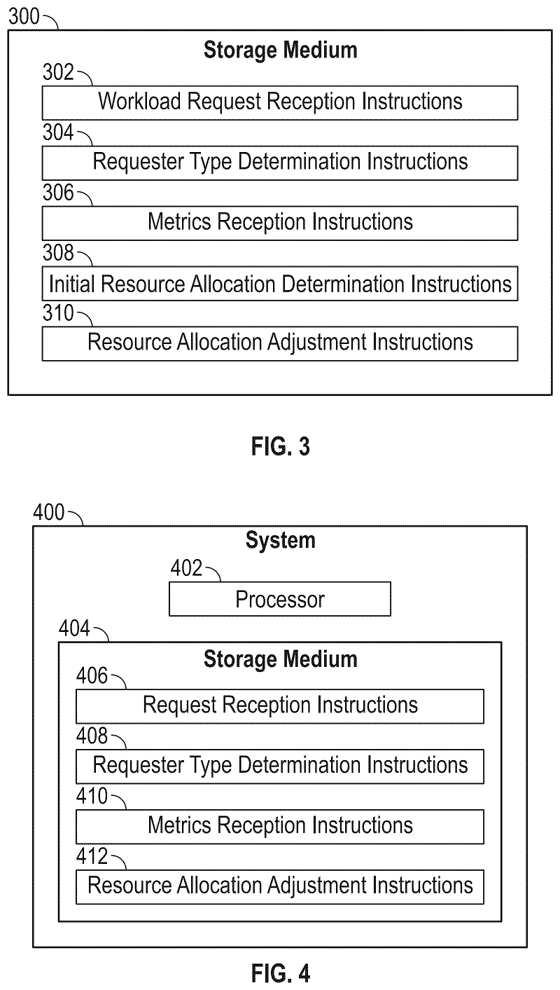

FIG. 3 is a block diagram of a non-transitory machine-readable or computer-readable storage medium 300 storing machine-readable instructions that upon execution cause a workload management system to perform various tasks.

The machine-readable instructions include workload request reception instructions 302 to receive, from a requester, a request to perform a first workload in a virtual computing environment. The requester may be a user or another type of entity, such as a program or a machine. The virtual computing environment can include containers or VMs, for example.

The machine-readable instructions include requester type determination instructions 304 to determine a type of the requester, the determined type being one of a plurality of different requester types. The determination of the type of the requester may be based on assigning a profile of the requester to a group of requester profiles.

The machine-readable instructions include metrics reception instructions 306 to receive metrics relating to resource usage in the virtual computing environment. The metrics may be received from the monitoring system 116 of FIG. 1, for example.

The machine-readable instructions include initial resource allocation determination instructions 308 to determine, using a machine learning model, an allocation of resources to the first workload based on the determined type of the requester and the metrics. The allocation of resources can include a quantity of virtual compute entities to use for the first workload, which physical computing nodes the virtual compute entities are to run on, types of physical resources to employ for executing the first workload, or other types of resources.

The machine-readable instructions include resource allocation adjustment instructions 310 to adjust, using the machine learning model, the allocation of resources to the first workload based on further collected metrics relating to resource usage by the first workload and based on a detected behavior of the requester while the first workload is performed in the virtual computing environment.

Note that other workloads (e.g., subsequent or earlier workloads) of the requester or other requesters can be handled in similar fashion. For other requesters, different machine learning models may be used.

In some examples, the machine-readable instructions can determine whether the detected behavior of the requester indicates that the requester is engaging in workloads that deviate from expected workloads of the requester.

In some examples, the machine-readable instructions can change the allocation of resources to the first workload based on determining that the requester is engaging in workloads that deviate from the expected workloads. Changing the allocation of resources can refer to modifying the allocation of resources or denying or blocking further use of resources.

In some examples, the machine learning model can adjust the allocation of resources to the first workload by sending, from the machine learning model to a workload scheduler, information specifying a resource allocation that is used by the workload scheduler in providing the allocation of resources to the first workload. An example of the workload scheduler is the scheduler 128 of FIG. 1.

In some examples, the allocation of resources to the first workload includes an allocation of virtual compute entities in the virtual computing environment to execute the first workload.

In some examples, the allocation of resources to the first workload includes a selection of physical computing nodes of a computer system on which the virtual compute entities are run.

In some examples, the allocation of resources to the first workload includes selecting a resource type from a plurality of resource types, the selected resource type specifying a type of physical resource for use by the first workload.

In some examples, the machine learning model can determine the allocation of resources to the first workload further based on one or more of the following attributes: a time at which the first workload is to be run, a quantity of workloads running in the virtual computing environment, a geographic region in which the first workload is to be run, or historical usage of resources by workloads.

In some examples, the machine learning model can forecast an upcoming resource demand by workloads in the virtual computing environment, and adjust the allocation of resources to the first workload further based on the forecast upcoming resource demand.

In some examples, the machine learning model can adjust the allocation of resources to the first workload further based on a target for a metric of the metrics. The target may be one of the targets 162 of FIG. 1.

In some examples, the machine-readable instructions can dynamically adjust the target for the metric based on a detected behavior of the requester.

In some examples, the machine-readable instructions can determine the type of the requester based on a profile of the requester, the profile including attributes representing a resource usage pattern and performance levels of the requester.

In some examples, the profile further includes one or more of information relating to a role of the requester, one or more allowed types of resources for the requester, and permission information of the requester.

In some examples, the machine-readable instructions can obtain representations of groups of profiles (e.g., that are part of the groups information 122 of FIG. 1), and determine the type of the requester based on assigning the profile of the requester to a selected group of profiles from among the groups of profiles.

In some examples, the assigning of the profile of the requester to the selected group of profiles is based on distances of the profile of the requester to the groups of profiles.

In some examples, the machine-readable instructions can generate a visualization of metrics of resource usage by the first workload, wherein the visualization further includes information of an upcoming adjustment of resource allocation for the first workload.

FIG. 4 is a block diagram of a system 400 according to some examples. The system 400 may be implemented with one or more computers.

The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 further includes a storage medium 404 storing machine-readable instructions executable on the hardware processor 402 to perform various tasks. The machine-readable instructions in the storage medium 404 include request reception instructions 406 to receive, from a requester, a request to perform a workload in a virtual computing environment.

The machine-readable instructions in the storage medium 404 include requester type determination instructions 408 to determine based on a relationship of a profile of the requester to groups of profiles, a type of the requester, the determined type being one of a plurality of different requester types. The machine-readable instructions can assign the profile to a group of profiles based on determining a distance of the profile to the group of profiles in a vector space.

The machine-readable instructions in the storage medium 404 include metrics reception instructions 410 to receive metrics relating to resource usage in the virtual computing environment.

The machine-readable instructions in the storage medium 404 include resource allocation adjustment instructions 412 to determine, using a machine learning model, an allocation of resources to the workload based on the determined type of the requester and the metrics, wherein the allocation of resources comprises a quantity of virtual compute entities to use for performing the workload, and a type of a physical resource to use.

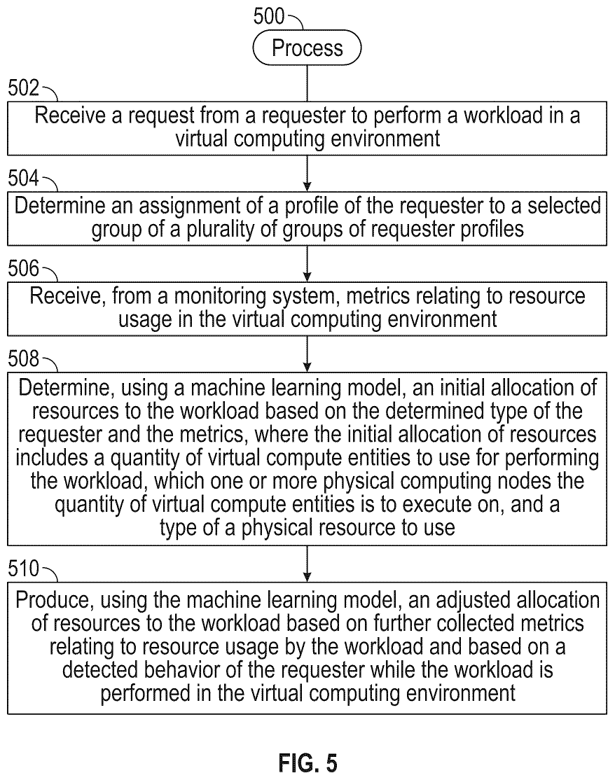

FIG. 5 is a flow diagram of a process 500, which may be performed by the proactive workload management engine 102 of FIG. 1, for example. The process 500 includes receiving (at 502) a request from a requester to perform a workload in a virtual computing environment.

The process 500 includes determining (at 504) an assignment of a profile of the requester to a selected group of a plurality of groups of requester profiles. The assignment can include determining distances of the profile to respective groups of the plurality of groups of requester profiles.

The process 500 includes receiving (at 506), from a monitoring system, metrics relating to resource usage in the virtual computing environment. The metrics can be from sensors that collect metrics associated with operations of a compute cluster (e.g., 108 in FIG. 1) while workloads are performed by virtual compute entities on respective physical computing nodes (e.g., 106A and 106B in FIG. 1).

The process 500 includes determining (at 508), using a machine learning model, an initial allocation of resources to the workload based on the determined type of the requester and the metrics, where the allocation of resources includes a quantity of virtual compute entities to use for performing the workload, which one or more physical computing nodes the quantity of virtual compute entities is to execute on, and a type of a physical resource to use.

The process 500 includes producing (at 510), using the machine learning model, an adjusted allocation of resources to the workload based on further collected metrics relating to resource usage by the workload and based on a detected behavior of the requester while the workload is performed in the virtual computing environment.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

Although FIG. 1 shows the proactive workload management engine 102, the user management engine 118, the monitoring system 116, and the scheduler 128 as separate components, in other examples, two or more of the foregoing components may be integrated into one component.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a workload management system to:
receive, from a requester, a request to perform a first workload in a virtual computing environment;
determine a type of the requester, the determined type being one of a plurality of different requester types;
receive metrics relating to resource usage in the virtual computing environment;
determine, using a machine learning model, an allocation of resources to the first workload based on the determined type of the requester and the metrics; and
adjust, using the machine learning model, the allocation of resources to the first workload based on further collected metrics relating to resource usage by the first workload and based on a detected behavior of the requester while the first workload is performed in the virtual computing environment.

2. The non-transitory machine-readable storage medium of claim 1, wherein the instructions upon execution cause the workload management system to:
determine whether the detected behavior of the requester indicates that the requester is engaging in workloads that deviate from expected workloads of the requester.

3. The non-transitory machine-readable storage medium of claim 2, wherein the instructions upon execution cause the workload management system to:
based on determining that the requester is engaging in workloads that deviate from the expected workloads, change the allocation of resources to the first workload.

4. The non-transitory machine-readable storage medium of claim 1, wherein the instructions upon execution cause the workload management system to:
adjust, using the machine learning model, the allocation of resources to the first workload by sending, from the machine learning model to a workload scheduler, information specifying a resource allocation that is used by the workload scheduler in providing the allocation of resources to the first workload.

5. The non-transitory machine-readable storage medium of claim 1, wherein the allocation of resources to the first workload comprises an allocation of virtual compute entities in the virtual computing environment to execute the first workload.

6. The non-transitory machine-readable storage medium of claim 5, wherein the allocation of resources to the first workload comprises a selection of physical computing nodes of a computer system on which the virtual compute entities are run.

7. The non-transitory machine-readable storage medium of claim 1, wherein the allocation of resources to the first workload comprises selecting a resource type from a plurality of resource types, the selected resource type specifying a type of physical resource for use by the first workload.

8. The non-transitory machine-readable storage medium of claim 1, wherein the instructions upon execution cause the workload management system to:
determine, using the machine learning model, the allocation of resources to the first workload further based on one or more of the following attributes: a time at which the first workload is to be run, a quantity of workloads running in the virtual computing environment, a geographic region in which the first workload is to be run, or historical usage of resources by workloads.

9. The non-transitory machine-readable storage medium of claim 1, wherein the instructions upon execution cause the workload management system to:
forecast, using the machine learning model, an upcoming resource demand by workloads in the virtual computing environment, and
adjust, using the machine learning model, the allocation of resources to the first workload further based on the forecast upcoming resource demand.

10. The non-transitory machine-readable storage medium of claim 1, wherein the instructions upon execution cause the workload management system to:
adjust, using the machine learning model, the allocation of resources to the first workload further based on a target for a metric of the metrics.

11. The non-transitory machine-readable storage medium of claim 10, wherein the instructions upon execution cause the workload management system to:
dynamically adjust the target for the metric based on a detected behavior of the requester.

12. The non-transitory machine-readable storage medium of claim 1, wherein the instructions upon execution cause the workload management system to:
determine the type of the requester based on a profile of the requester, the profile comprising attributes representing a resource usage pattern and performance levels of the requester.

13. The non-transitory machine-readable storage medium of claim 12, wherein the profile further comprises one or more of information relating to a role of the requester, one or more allowed types of resources for the requester, and permission information of the requester.

14. The non-transitory machine-readable storage medium of claim 12, wherein the instructions upon execution cause the workload management system to:
obtain representations of groups of profiles; and
determine the type of the requester based on assigning the profile of the requester to a selected group of profiles from among the groups of profiles.

15. The non-transitory machine-readable storage medium of claim 14, wherein the assigning of the profile of the requester to the selected group of profiles is based on distances of the profile of the requester to the groups of profiles.

16. The non-transitory machine-readable storage medium of claim 1, wherein the instructions upon execution cause the workload management system to:
generate a visualization of metrics of resource usage by the workload, wherein the visualization further comprises information of an upcoming adjustment of resource allocation for the workload.

17. A system comprising:
a processor; and
a non-transitory storage medium comprising instructions executable on the processor to:
receive, from a requester, a request to perform a workload in a virtual computing environment;
determine based on a relationship of a profile of the requester to groups of profiles, a type of the requester, the determined type being one of a plurality of different requester types;
receive metrics relating to resource usage in the virtual computing environment; and
determine, using a machine learning model, an allocation of resources to the workload based on the determined type of the requester and the metrics, wherein the allocation of resources comprises a quantity of virtual compute entities to use for performing the workload, and a type of a physical resource to use.

18. The system of claim 17, wherein the instructions are executable on the processor to:
adjust, using the machine learning model, the allocation of resources to the workload based on further collected metrics relating to resource usage by the workload and based on a detected behavior of the requester while the workload is performed in the virtual computing environment.

19. A method comprising:
receiving, by a system comprising a hardware processor, a request from a requester to perform a workload in a virtual computing environment;
determining, by the system, an assignment of a profile of the requester to a selected group of a plurality of groups of requester profiles;
receiving, by the system from a monitoring system, metrics relating to resource usage in the virtual computing environment;
determining, using a machine learning model executed in the system, an initial allocation of resources to the workload based on the determined type of the requester and the metrics, wherein the allocation of resources comprises a quantity of virtual compute entities to use for performing the workload, which one or more physical computing nodes the quantity of virtual compute entities is to execute on, and a type of a physical resource to use; and
producing, using the machine learning model, an adjusted allocation of resources to the workload based on further collected metrics relating to resource usage by the workload and based on a detected behavior of the requester while the workload is performed in the virtual computing environment.

20. The method of claim 19, comprising:
producing, using the machine learning model, the adjusted allocation of resources to the workload further based on a target for a metric of the metrics; and
dynamically adjust the target for the metric based on a detected behavior of the requester.
